(19) United States
(12) Patent Application Publication
(10) Pub. No.: US 2013/0070560 A1
(43) Pub. Date: Mar. 21, 2013

(54) Arranging Source-Receiver Orientations to Reduce High-Order Modes in Acoustic Monopole Logging

(71) Applicants: Yibing Zheng, Houston, TX (US); Xiao Ming Tang, Sugar Land, TX (US); Douglas J. Patterson, Speing, TX (US); David H. Lilly, Houston, TX (US)

(72) Inventors: Yibing Zheng, Houston, TX (US); Xiao Ming Tang, Sugar Land, TX (US); Douglas J. Patterson, Speing, TX (US); David H. Lilly, Houston, TX (US)

(73) Assignee: Baker Hughes Incorporated, Houston, TX (US)

(21) Appl. No.: 13/237,335

(22) Filed: Sep. 20, 2011

(51) Int. Cl. G01V 1/00

(52) U.S. Cl. 367/25

(57) ABSTRACT

The present disclosure relates to methods and apparatuses for estimating a parameter of interest of an earth formation. The method may include using an acoustic sensor azimuthally positioned relative to a monopole acoustic source to reduce at least one high-order mode due to the monopole acoustic source. The monopole acoustic source may include one or more acoustic elements. The method may include generating a monopole acoustic pulse. The apparatus may include at least one acoustic source element and at least one acoustic sensor disposed on a housing configured for conveyance in a borehole. The at least one acoustic sensor may be azimuthally positioned relative to the at least one acoustic source to reduce at least one high-order mode.

### BACKGROUND OF THE DISCLOSURE

1. Field of the Disclosure

This disclosure generally relates to exploration and production of hydrocarbons involving investigations of regions of an earth formation penetrated by a borehole. More specifically, the disclosure relates to reducing at least one high-order mode generated by an acoustic monopole source in the borehole.

2. Description of the Related Art

The exploration for and production of hydrocarbons may involve a variety of techniques for characterizing earth formations. Acoustic logging tools for measuring properties of the sidewall material of both cased and uncased boreholes are well known. Essentially such tools measure the travel time of an acoustic pulse propagating through the sidewall material over a known distance. In some studies, the amplitude and frequency of the acoustic pulse, after passage through the earth, are of interest.

In its simplest form, an acoustic logger may include one or more transmitter transducers that periodically emit an acoustic signal into the formation around the borehole. One or more acoustic sensors, spaced apart by a known distance from the transmitter, may receive the signal after passage through the surrounding formation. The difference in time between signal transmission and signal reception divided into the distance between the transducers is the formation velocity. If the transducers do not contact the borehole sidewall, allowance must be made for time delays through the borehole fluid.

Throughout this disclosure, the term “velocity”, unless otherwise qualified, shall be taken to mean the velocity of propagation of an acoustic wavefield through an elastic medium. Acoustic wavefields propagate through elastic media in different modes. The modes include: compressional or P-waves, wherein particle motion is in the direction of wave travel; transverse shear or S-waves, which, assuming a homogeneous, isotropic medium, may be polarized in two orthogonal directions, with motion perpendicular to the direction of wave travel; Stoneley waves, which are guided waves that propagate along the fluid-solid boundary of the borehole; and compressional waves that propagate through the borehole fluid itself. There also exist asymmetrical flexural waves as will be discussed later.

P-waves propagate through both fluids and solids. Shear waves cannot exist in a fluid. Compressional waves propagating through the borehole fluid may be mode-converted to shear waves in the borehole sidewall material by refraction provided the shear-wave velocity of the medium is greater than the compressional-wave velocity of the borehole fluids. If that is not true, then shear waves in the sidewall material can be generated only by direct excitation.

Among other parameters, the various modes of propagation are distinguishable by their relative velocities. The velocity of compressional and shear waves is a function of the elastic constants and the density of the medium through which the waves travel. The S-wave velocity is, for practical purposes, about half that of P-waves. Stoneley waves may be somewhat slower than S-waves. Compressional wavefields propagating through the borehole fluid are usually slower than formational shear waves but for boreholes drilled into certain types of soft formations, the borehole fluid velocity may be greater than the sidewall formation S-wave velocity. The velocity of flexural waves is said to approach the S-wave velocity as an inverse function of the acoustic excitation frequency. Flexural waves may also be called pseudo-Raleigh waves.

In borehole logging, a study of the different acoustic propagation modes provides diagnostic information about the elastic constants of the formation, rock texture, fluid content, permeability, rock fracturing, the goodness of a cement bond to the well casing and other data. Typically, the output display from an acoustic logging tool takes the form of time-scale recordings of the wave train as seen at many different depth levels in the borehole, each wave train including many overlapping events that represent all of the wavefield propagation modes. For quantitative analysis, it is necessary to isolate the respective wavefield modes. S-waves are of particular interest. But because the S-wave arrival time is later than the P-wave arrival time, the S-wave event often is contaminated by later cycles of the P-wave and by interference from other late-arriving events. Therefore, known logging tools are designed to suppress undesired wave fields either by judicious design of the hardware or by post-processing using suitable software. Both monopole and dipole signals may be transmitted and received using appropriately configured transducers.

### SUMMARY OF THE DISCLOSURE

In view of the foregoing, the present disclosure is directed to a method and apparatus for estimating at least one parameter of interest of an earth formation using one an acoustic tool configured to reduce at least one high-order mode of an acoustic pulse from a monopole acoustic source in a borehole.

One embodiment according to the present disclosure includes a method of estimating at least one parameter of interest of an earth formation, comprising: estimating the at least one parameter of interest using a signal generated by at least one acoustic sensor in a borehole penetrating the earth formation, the at least one acoustic sensor being azimuthally positioned to reduce at least one high-order mode generated by an acoustic monopole source.

Another embodiment according to the present disclosure includes an apparatus for estimating at least one parameter of interest of an earth formation, comprising: a carrier configured to be conveyed in a borehole penetrating the earth formation; a monopole acoustic source disposed on the carrier and configured to generate at least one monopole acoustic pulse in a borehole fluid in communication with the earth formation; at least one acoustic sensor disposed on the carrier, configured to generate a signal indicative of a response from the earth formation to the at least one monopole acoustic pulse, and azimuthally positioned to reduce at least one high-order mode generated by the monopole acoustic source; and at least one processor configured to: estimate the at least one parameter of interest using the signal.

### BRIEF DESCRIPTION OF THE DRAWINGS

The present disclosure is best understood with reference to the accompanying figures in which like numerals refer to like elements and in which like numerals refer to like elements and in which:

FIG. 1 is a schematic of a drilling site including an acoustic tool for estimating at least one parameter of interest of an earth formation according to one embodiment of the present disclosure;

FIG. 2 is a schematic of an acoustic tool according to one embodiment of the present disclosure;

FIG. 3A is a schematic of acoustic pressure in a borehole due to a monopole mode generated by a monopole source according to one embodiment of the present disclosure;

FIG. 3B is a schematic of acoustic pressure in a borehole due to a dipole mode generated by a monopole source according to one embodiment of the present disclosure;

FIG. 3C is a schematic of acoustic pressure in a borehole due to a quadrupole mode generated by a monopole source according to one embodiment of the present disclosure;

FIG. 4 is a schematic of an acoustic tool in a borehole according to one embodiment of the present disclosure;

FIG. 5 is a flow chart of a method according to one embodiment of the present disclosure;

FIG. 6 is a chart showing an acoustic response due to an acoustic source with an in-line acoustic sensor according to one embodiment of the present disclosure;

FIG. 7 is a chart showing the acoustic response of FIG. 6 separated into monopole and quadrupole components according to one embodiment of the present disclosure; and

FIG. 8 is a chart showing a monopole acoustic response of FIG. 7 with an acoustic response from an azimuthally positioned sensor according to one embodiment of the present disclosure.

### DETAILED DESCRIPTION OF THE DISCLOSURE

In the disclosure that follows, in the interest of clarity, not all features of actual implementations are described. It will of course be appreciated that in the development of any such actual implementation, as in any such project, numerous engineering and technical decisions must be made to achieve the developers' specific goals and subgoals (e.g., compliance with system and technical constraints), which will vary from one implementation to another. Moreover, attention will necessarily be paid to proper engineering and programming practices for the environment in question. It will be appreciated that such development efforts may be complex and time-consuming, outside the knowledge base of typical laymen, but would nevertheless be a routine undertaking for those of ordinary skill in the relevant fields.

Monopole acoustic logging may be used to estimate parameters of interest of the earth formation, such as, but not limited to, the rock compressional and shear velocities, compressional and shear wave absorption, formation permeability, detection and location of fractures and fracture permeability. One of cost-effective designs of monopole-only acoustic LWD tools is using one single acoustic source element placed on one side of the tool, and positioning sensors aligned with the source. In this design, the acoustic source may generate not only the monopole mode but also some higher order modes (such as dipole and quadruple modes, etc.), which are all received by the sensors. Positioning the sensor/sensor array at some azimuthal angles from the source's azimuth may reduce the contamination of high order modes and enhance the monopole mode. The reduction technique may be applied with acoustic tools using one or more source elements. When an acoustic source includes a plurality of source elements, the azimuthal offset may be relative to one of the elements.

The monopole mode is the mode whose acoustic pressures around the tool are either all positive or all negative at the same time. There is no azimuthal phase variation in monopole mode, while a dipole mode has two phase changes around the tool and a quadrupole mode has four. Since the monopole mode does not have azimuthal variation, to receive the monopole mode, the sensors can be placed at any azimuthal position. If the sensors are positioned at an angle of 90 degree from the source position, where the dipole mode has no energy, the sensors may not record the dipole mode. If the sensors are placed about 45 degrees from the source position, the quadrupole mode may not be received. For example, the high-order modes may be reduced along a range relative to the 90 degree and 45 degree positions. In some embodiments, the sensors can be placed in the range of 75 to 105 degree to minimize the dipole mode and 35 to 55 degree to minimize the quadrupole mode. Illustrative embodiments of the present claimed subject matter are described in detail below.

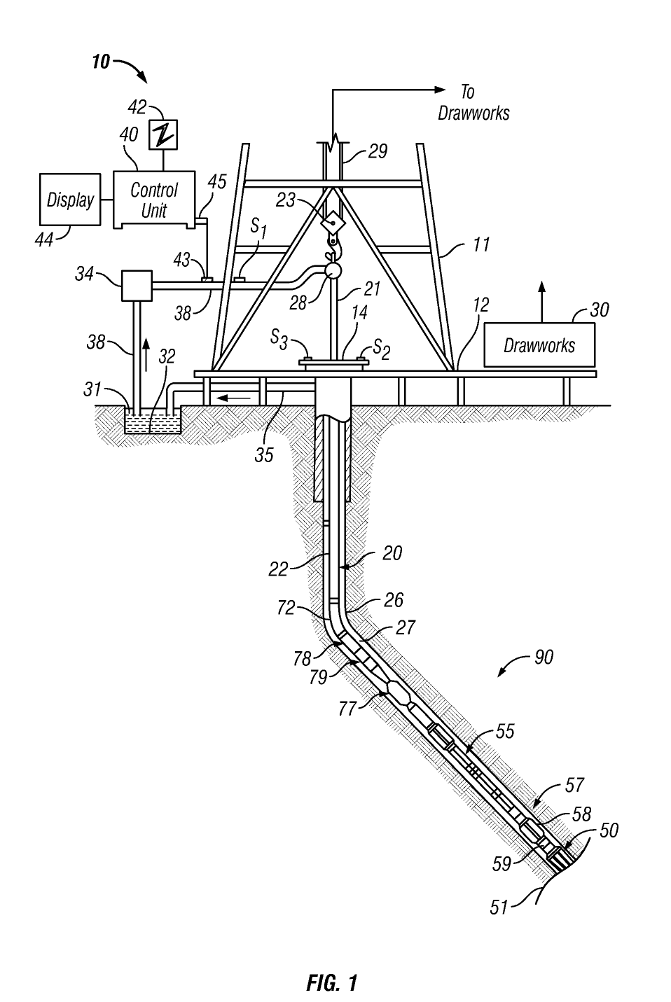

FIG. 1 shows a schematic diagram of a drilling system 10 with a drillstring 20 carrying a drilling assembly 90 (also referred to as the bottomhole assembly, or “BHA”) conveyed in a “wellbore” or “borehole” 26 for drilling the borehole. The drilling system 10 includes a conventional derrick 11 erected on a floor 12 which supports a rotary table 14 that is rotated by a prime mover such as an electric motor (not shown) at a desired rotational speed. The drillstring 20 includes tubing such as a drill pipe 22 or a coiled-tubing extending downward from the surface into the borehole 26. The drillstring 20 is pushed into the borehole 26 when a drill pipe 22 is used as the tubing. For coiled-tubing applications, a tubing injector, such as an injector (not shown), however, is used to move the tubing from a source thereof, such as a reel (not shown), to the borehole 26. The drill bit 50 attached to the end of the drillstring breaks up the geological formations when it is rotated to drill the borehole 26. If a drill pipe 22 is used, the drillstring 20 is coupled to a drawworks 30 via a kelly joint 21, swivel 28, and line 29 through a pulley 23. During drilling operations, the drawworks 30 is operated to control the weight on bit, which is an important parameter that affects the rate of penetration. The operation of the drawworks is well known in the art and is thus not described in detail herein.

During drilling operations, a suitable drilling fluid 31 from a mud pit (source) 32 is circulated under pressure through a channel in the drillstring 20 by a mud pump 34. The drilling fluid passes from the mud pump 34 into the drillstring 20 via a desurger (not shown), fluid line 38 and kelly joint 21. The drilling fluid 31 is discharged at the borehole bottom 51 through an opening in the drill bit 50. The drilling fluid 31 circulates uphole through the annular space 27 between the drillstring 20 and the borehole 26 and returns to the mud pit 32 via a return line 35. The drilling fluid acts to lubricate the drill bit 50 and to carry borehole cutting or chips away from the drill bit 50. A sensor S₁ placed in the line 38 can provide information about the fluid flow rate. A surface torque sensor S₂ and a sensor S₃ associated with the drillstring 20 respectively provide information about the torque and rotational speed of the drillstring. Additionally, a sensor (not shown) associated with line 29 is used to provide the hook load of the drillstring 20.

In one embodiment of the disclosure, the drill bit 50 is rotated by only rotating the drill pipe 22. In another embodiment of the disclosure, a downhole motor 55 (mud motor) is disposed in the drilling assembly 90 to rotate the drill bit 50 and the drill pipe 22 is rotated usually to supplement the rotational power, if required, and to effect changes in the drilling direction.

In one embodiment of FIG. 1, the mud motor 55 is coupled to the drill bit 50 via a drive shaft (not shown) disposed in a bearing assembly 57. The mud motor rotates the drill bit 50 when the drilling fluid 31 passes through the mud motor 55 under pressure. The bearing assembly 57 supports the radial and axial forces of the drill bit. A stabilizer 58 coupled to the bearing assembly 57 acts as a centralizer for the lowermost portion of the mud motor assembly.

In one embodiment of the disclosure, a drilling sensor module 59 is placed near the drill bit 50. The drilling sensor module may contain sensors, circuitry, and processing software and algorithms relating to the dynamic drilling parameters. Such parameters can include bit bounce, stick-slip of the drilling assembly, backward rotation, torque, shocks, borehole and annulus pressure, acceleration measurements, and other measurements of the drill bit condition. A suitable telemetry or communication sub 77 using, for example, two-way telemetry, is also provided as illustrated in the drilling assembly 90. The drilling sensor module processes the sensor information and transmits it to the surface control unit 40 via the telemetry system 77.

The communication sub 77, a power unit 78 and an MWD tool 79 are all connected in tandem with the drillstring 20. Flex subs, for example, are used in connecting the MWD tool 79 in the drilling assembly 90. Such subs and tools may form the bottom hole drilling assembly 90 between the drillstring 20 and the drill bit 50. The drilling assembly 90 may make various measurements including the pulsed nuclear magnetic resonance measurements while the borehole 26 is being drilled. The communication sub 77 obtains the signals and measurements and transfers the signals, using two-way telemetry, for example, to be processed on the surface. Alternatively, the signals can be processed using a downhole processor at a suitable location (not shown) in the drilling assembly 90.

The surface control unit or processor 40 may also receive one or more signals from other downhole sensors and devices and signals from sensors S1-S3 and other sensors used in the system 10 and processes such signals according to programmed instructions provided to the surface control unit 40. The surface control unit 40 may display desired drilling parameters and other information on a display/monitor 44 utilized by an operator to control the drilling operations. The surface control unit 40 can include a computer or a microprocessor-based processing system, memory for storing programs or models and data, a recorder for recording data, and other peripherals. The control unit 40 can be adapted to activate alarms 42 when certain unsafe or undesirable operating conditions occur.

While a drill string 20 is shown as a conveyance system for BHA 90, it should be understood that embodiments of the present disclosure may be used in connection with tools conveyed via rigid (e.g. jointed tubular or coiled tubing) as well as non-rigid (e. g. wireline, slickline, e-line, etc.) conveyance systems. A downhole assembly (not shown) may include a bottomhole assembly and/or sensors and equipment for implementation of embodiments of the present disclosure on either a drill string or a wireline.

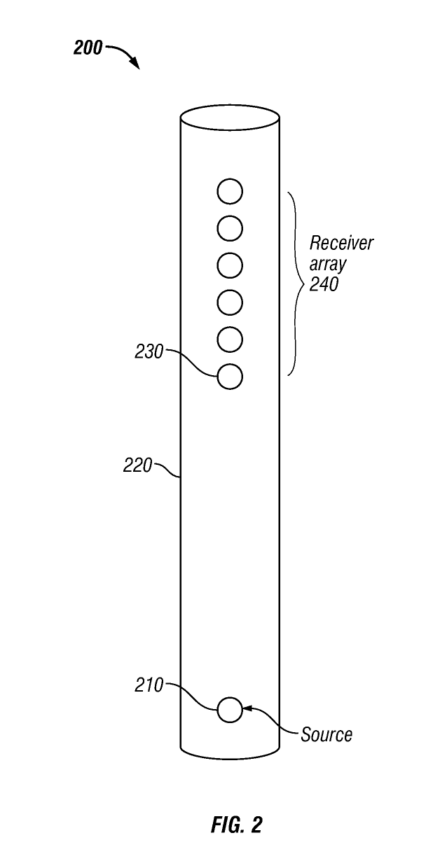

FIG. 2 shows a schematic of an acoustic tool 200 for use with BHA 90. Acoustic tool 200 may include one or more acoustic source elements (or poles) 210 disposed on a housing 220. The housing 220 may be part of drill string 20. Acoustic tool 200 may include one or more acoustic sensors 230. In multiple sensor embodiments, the acoustic sensors 230 may be arranged in a sensor array 240.

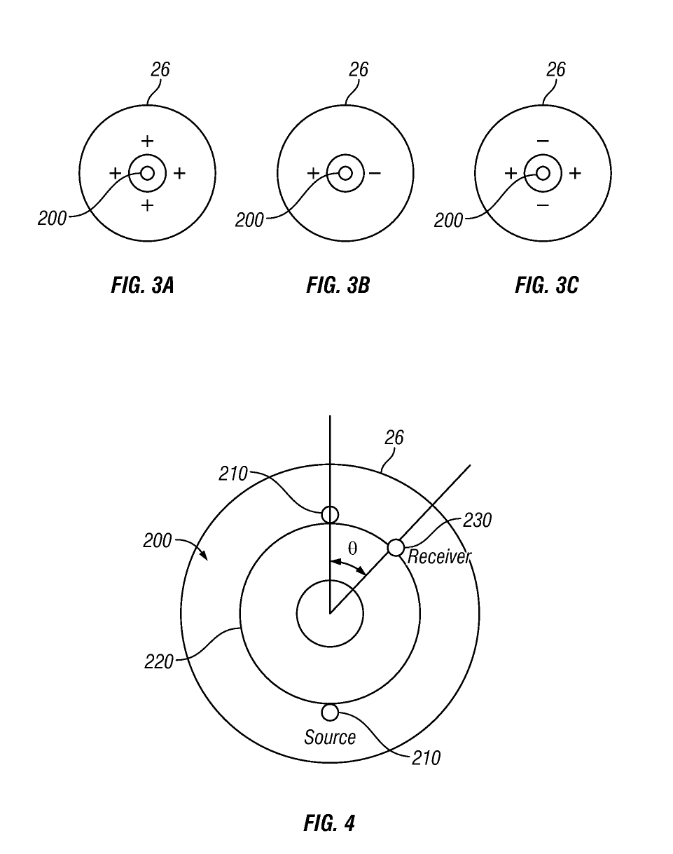

FIGS. 3A-3C show diagrams of the acoustic pressures generated by modes that may be produced by a monopole source in a borehole. FIG. 3A shows the acoustic pressures around tool 200 in borehole 26 due to the monopole mode. FIG. 3B shows the acoustic pressures around tool 200 in borehole 26 due to the dipole mode. FIG. 3C shows the acoustic pressures around tool 200 in borehole 26 due to the quadrupole mode. It may be observed that the acoustic pressures due to the monopole mode in FIG. 3A do not vary azimuthally, while the acoustic pressures due to dipole mode in FIG. 3B and quadrupole mode in FIG. 3C do vary azimuthally.

FIG. 4 shows a top view schematic of acoustic tool 200 configured for reduced quadrupole mode signals. Two acoustic source elements 210 may be positioned 180 degrees apart on the outside of housing 220. The acoustic source elements 210 may be configured to operate in phase to generate a monopole signal. The use of two acoustic source elements 210 is illustrative and exemplary only, as a single acoustic source element or a plurality of acoustic source elements may be used as long as the elements are substantially in phase so as to generate a monopole signal. One or more sensors 230 may be positioned along the outside of housing 220 at an angle θ between about 35 and about 55 degrees from one of the acoustic sources 210. In configurations for reducing dipole mode signals, one or more sensors may be positioned when the angle θ is between about 75 and about 105 degrees. In embodiments where two identical source elements 210 are placed back to back on the tool 200 (180 degrees apart), the dipole mode may not be excited at all. If the sensor array is placed in the range of 35 to 55 degree, the quadrupole mode may be minimized so that the monopole mode is enhanced.

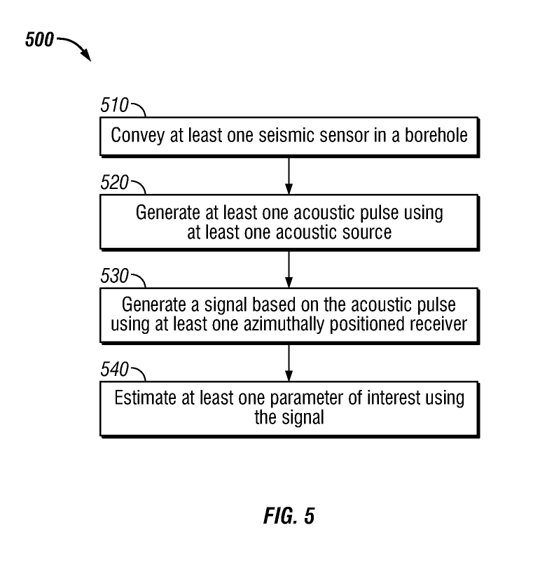

FIG. 5 shows a flow chart illustrating a method 500 according to one embodiment of the present disclosure. In step 510, acoustic tool 200 including at least one acoustic source element 210 and at least one acoustic sensor 230 may be conveyed in the borehole 26. In step 520, a monopole acoustic pulse may be generated by at least one acoustic source element 210. The at least one acoustic source element 210 may include multiple acoustic sources that are substantially in phase with one another. In step 530, at least one acoustic sensor 230 may generate a signal indicative of a response of the borehole 26 to the acoustic pulse. The at least one acoustic sensor 230 may be azimuthally positioned relative to the at least one acoustic source 210 to reduce at least one high-order mode. In an embodiment for reducing a dipole mode, the azimuthal position θ of the at least one acoustic sensor 230 may be about 75 to about 105 degrees from the at least one acoustic source 210. In an embodiment for reducing a quadropole mode, the azimuthal position θ of the at least one acoustic sensor 230 may be about 35 to about 55 degrees from the at least one acoustic source 210. In step 540, at least one parameter of interest of the formation may be estimated using the signal. The at least one parameter of interest may include one or more of: (i) compressional velocity and (ii) shear velocity.

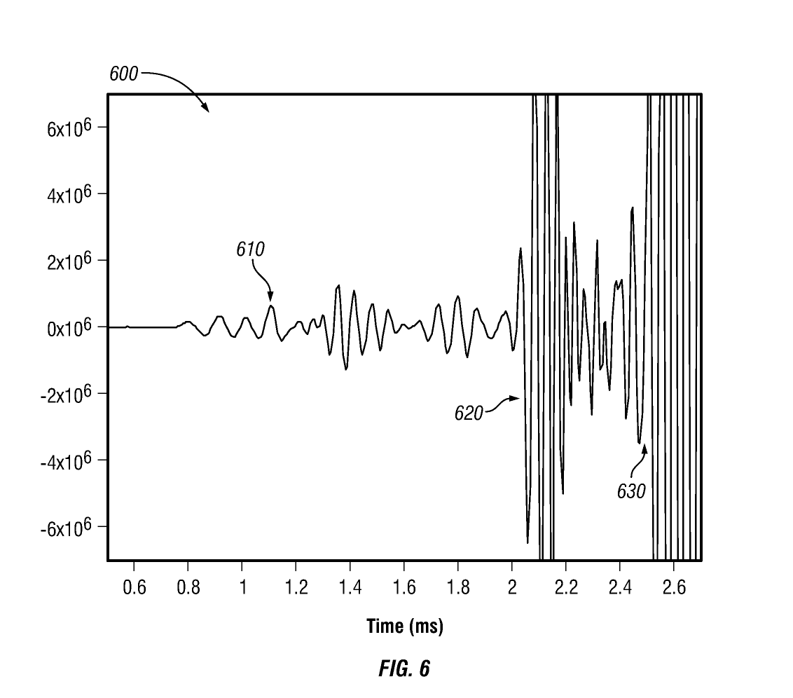

FIG. 6 shows a curve 600 representing an acoustic response to monopole acoustic source 210 as measured by an acoustic sensor 230 in a borehole 26, where the acoustic sensor 230 is in-line with the monopole acoustic source 210. Curve 600 may include compressional waves 610, shear waves 620, and Stoneley waves 630.

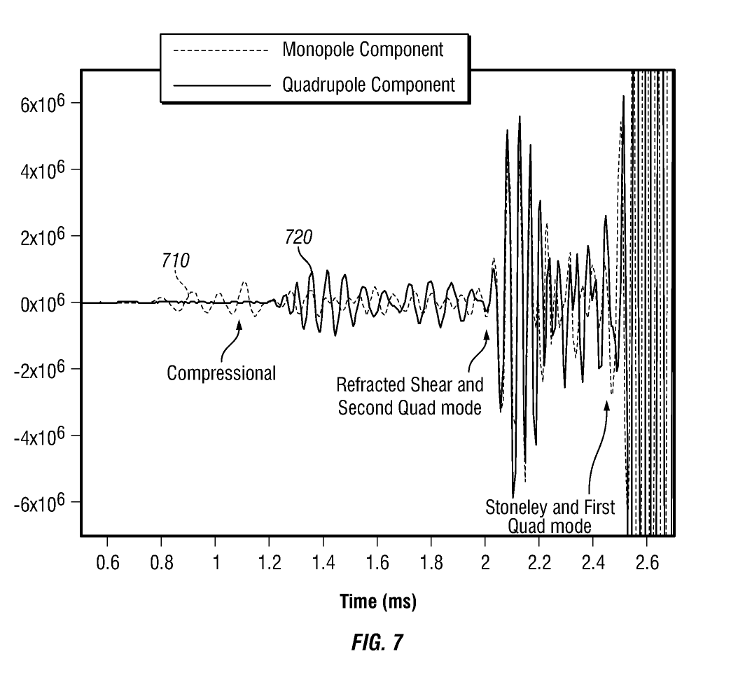

FIG. 7 shows curve 600 separated into a monopole tool component 710 and a quadrupole tool component 720.

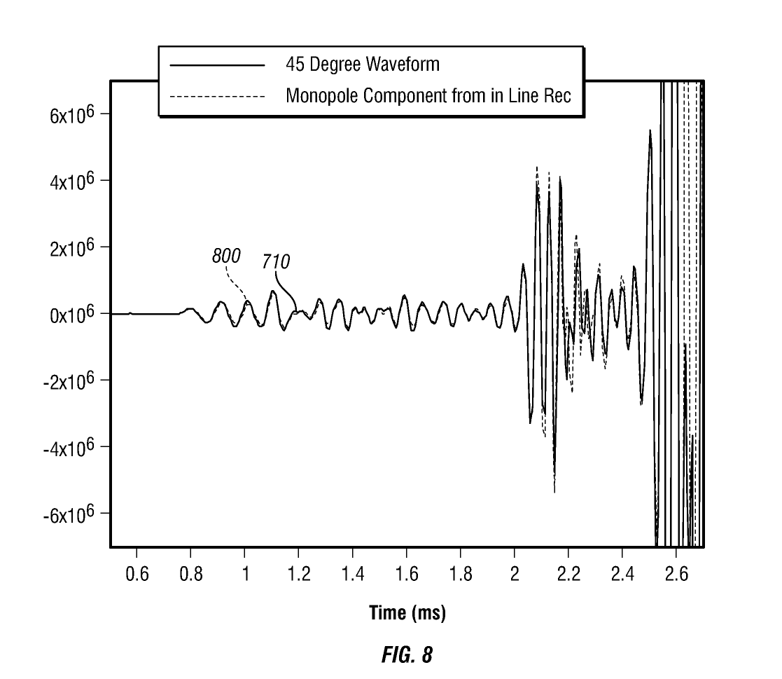

FIG. 8 shows curve 710 in comparison with a curve 800 representing an acoustic response to monopole acoustic source 210 when the acoustic sensor 230 is azimuthally positioned 45 degrees from the acoustic source 210.

As described herein, the method in accordance with the presently disclosed embodiment of the disclosure involves several computational steps. As would be apparent by persons of ordinary skill, these steps may be performed by computational means such as a computer, or may be performed manually by an analyst, or by some combination thereof. As an example, where the disclosed embodiment calls for selection of measured values having certain characteristics, it would be apparent to those of ordinary skill in the art that such comparison could be performed based upon a subjective assessment by an analyst or by computational assessment by a computer system properly programmed to perform such a function. To the extent that the present disclosure is implemented utilizing computer equipment to perform one or more functions, it is believed that programming computer equipment to perform these steps would be a matter of routine engineering to persons of ordinary skill in the art having the benefit of the present disclosure.

Implicit in the processing of the acquired data is the use of a computer program implemented on a suitable computational platform (dedicated or general purpose) and embodied in a suitable machine readable medium that enables the processor to perform the control and processing. The term “processor” as used in the present disclosure is intended to encompass such devices as microcontrollers, microprocessors, field-programmable gate arrays (FPGAs) and the storage medium may include ROM, RAM, EPROM, EAROM, solid-state disk, optical media, magnetic media and other media and/or storage mechanisms as may be deemed appropriate. As discussed above, processing and control functions may be performed downhole, at the surface, or in both locations.

Although a specific embodiment of the disclosure as well as possible variants and alternatives thereof have been described and/or suggested herein, it is to be understood that the present disclosure is intended to teach, suggest, and illustrate various features and aspects of the disclosure, but is not intended to be limiting with respect to the scope of the disclosure, as defined exclusively in and by the claims, which follow.

While the foregoing disclosure is directed to the specific embodiments of the disclosure, various modifications will be apparent to those skilled in the art. It is intended that all such variations within the scope of the appended claims be embraced by the foregoing disclosure.

What is claimed is:

1. A method of estimating at least one parameter of interest of an earth formation, comprising:
estimating the at least one parameter of interest using a signal generated by at least one acoustic sensor in a borehole penetrating the earth formation, the at least one acoustic sensor being azimuthally positioned to reduce at least one high-order mode generated by an acoustic monopole source.

2. The method of claim 1, further comprising:
generating a monopole acoustic pulse using the acoustic monopole source; and
generating the signal using the at least one acoustic sensor;

3. The method of claim 1, wherein the at least one parameter of interest includes at least one of: (i) compressional velocity, (ii) shear velocity, (iii) compressional wave absorption, (iv) shear wave absorption, (v) formation permeability, (vi) fracture location and (vii) fracture permeability.

4. The method of claim 1, wherein the at least one high-order mode includes at least one of: (i) a dipole mode, (ii) a quadrupole mode, and (iii) an octopole mode.

5. The method of claim 1, wherein the monopole source includes at least one acoustic source element.

6. The method of claim 1, wherein the monopole source includes a plurality of poles, where all of the poles are in phase with each other.

7. The method of claim 1, wherein the azimuthal position of the at least one acoustic sensor is one of: (i) about 75 to about 105 degrees for dipole mode reduction or (ii) about 35 to about 55 degrees for quadrupole mode reduction.

8. An apparatus for estimating at least one parameter of interest of an earth formation, comprising:
a carrier configured to be conveyed in a borehole penetrating the earth formation;
a monopole acoustic source disposed on the carrier and configured to generate at least one monopole acoustic pulse in a borehole fluid in communication with the earth formation;
at least one acoustic sensor disposed on the carrier, configured to generate a signal indicative of a response from the earth formation to the at least one monopole acoustic pulse, and azimuthally positioned to reduce at least one high-order mode generated by the monopole acoustic source; and
at least one processor configured to:
estimate the at least one parameter of interest using the signal.

9. The apparatus of claim 8, wherein the at least one parameter of interest includes at least one of: (i) compressional velocity, (ii) shear velocity, (iii) compressional wave absorption, (iv) shear wave absorption, (v) formation permeability, (vi) fracture location and (vii) fracture permeability.

10. The apparatus of claim 8, wherein the at least one high-order mode includes at least one of: (i) a dipole mode, (ii) a quadrupole mode, and (iii) an octopole mode.

11. The apparatus of claim 8, wherein the acoustic source includes at least one acoustic source element.

12. The apparatus of claim 8, wherein the monopole acoustic source includes a plurality of acoustic source elements, wherein monopole acoustic source is configured to generate the acoustic pulse with the all of the acoustic source elements in phase with each other.

13. The apparatus of claim 8, wherein the azimuthal position of the at least one acoustic sensor is one of: (i) about 75 to about 105 degrees for dipole mode reduction or (ii) about 35 to about 55 degrees for quadrupole mode reduction.
